(19) United States
(12) Patent Application Publication
(10) Pub. No.: US 2010/0179457 A1
(43) Pub. Date: Jul. 15, 2010

(54) VIBRATING ANESTHESIA DEVICE

(75) Inventors: ROBERT C. BLAINE, Buena Park, CA (US); CURTIS TAYLOR, Chagrin Falls, OH (US)

Correspondence Address: MCKEE, VOORHEES & SEASE, P.L.C., 801 GRAND AVENUE, SUITE 3200, DES MOINES, IA, 50309-2721, US

(73) Assignee: BLAINE LABORATORIES, INC., Santa Fe Springs, CA (US)

(21) Appl. No.: 12/499,424

(22) Filed: Jul. 8, 2009

Related U.S. Application Data
(60) Provisional application No. 61/078,885, filed on Jul. 8, 2008.

(51) Int. Cl. A61H 1/00

(52) U.S. Cl. 601/46

(57) ABSTRACT

A hand-held vibrating tool is provided to create an anesthesia effect on a patient's skin when the tool is touched to the skin. The tool includes a body which is easily grasped by the user and a removable tip having forked prongs for touching the skin. A small electric motor is housed within the body and is powered by batteries, with an on/off switch to control actuation of the motor. The motor generates vibrations which are transmitted through the prongs to the patient's skin, and thereby create a numbed zone prior to a medical procedure, such as an injection. Interchangeable tips are provided with differently spaced prongs to create smaller or larger anesthetized zones for the patient.

### CROSS-REFERENCE TO RELATED APPLICATIONS

This application claims priority under 35 U.S.C. §119(e) to provisional application Ser. No. 61/078,885 filed Jul. 8, 2008. herein incorporated by reference in its entirety.

### BACKGROUND OF THE INVENTION

Vibratory anesthesia is known in the medical industry as a method for temporarily numbing an area or zone on a patient prior to a medical procedure, such as an injection by a syringe. The general concept behind such vibration anesthesia is the neurontransmitter depletion of alpha and C fibers of nerves which carry pain sensation. More particularly, according to one pain theory, certain nerve fibers which transmit information from vibration and touch receptors in the skin, stimulate inhibitory interneurons in the spinal cord, which in turn, act to reduce the amount of pain signal transmitted by alpha and C fibers from the skin to second-order neurons to cross the midline of the spinal cord and then ascend to the brain.

The anesthetic or analgesic effect of the vibrations minimizes pain in the patient undergoing an injection or other painful treatment. This vibration technique also calms patients who are needle-phobic. Vibratory anesthesia can also be used as a substitute for conventional injectable local anesthetics. In addition to the neurophysiological effect of vibration to reduce pain transmission, vibration may also have an additive placebo affect.

Cutaneous vibrators have also been used to relieve pain associated with a variety of dermatology procedures, including injections and laser treatments, for example, using a tripod muscle massager.

A primary objective of the present invention is the provision of a small device or tool which can be easily held or mounted on the hand for use by a medical professional or a patient to anesthetize a zone on the patient's skin prior to a procedure, such as an injection or drawing of blood.

Another objective of the present invention is the provision of a hand-held vibrating anesthesia device having interchangeable heads with different diameter prongs.

A further objective of the present invention is the provision of a vibrating anesthesia tool which can be easily grasped by people having different sized hands. Still another objective of the present invention is the provision of a vibrating anesthesia tool which provides a target spot on an anesthesia zone on the patient's skin.

Yet another objective of the present invention is the provision of a vibrating anesthesia tool having a funny or whimsical noise generator to distract children during use.

Another objective of the present invention is the provision of a vibrating anesthesia tool having a forked body to extend around a user's finger for easy grasping.

Yet another objective of the present invention is the provision of a vibrating anesthesia tool having a pair of curved prongs which can be held against a patient's skin in different orientations to create a numbed zone on the skin.

A further objective of the present invention is the provision of a vibrating anesthesia tool which is battery powered so as to eliminate electrical cords.

Another objective of the present invention is the provision of a vibration anesthesia tool which is quick and easy to use, safe, highly effective, and inexpensive.

### BRIEF DESCRIPTION OF THE DRAWINGS AND PHOTOS

FIG. 1 is a perspective view of a preferred embodiment of the vibration anesthesia device of the present invention.

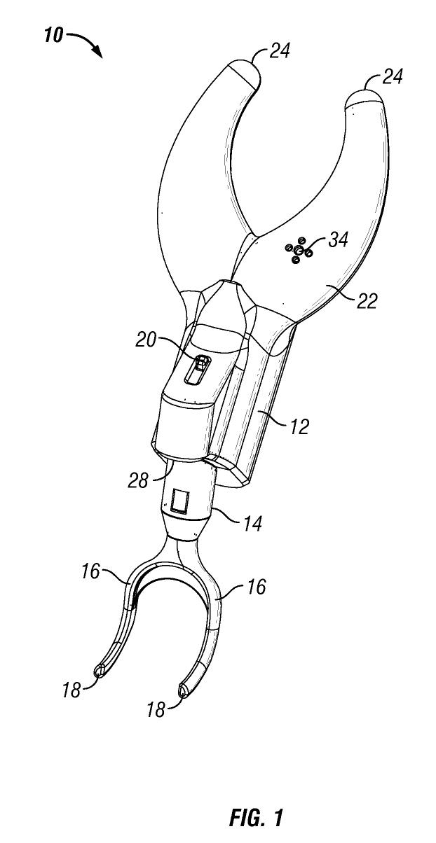

FIG. 2 is another perspective view of the device.

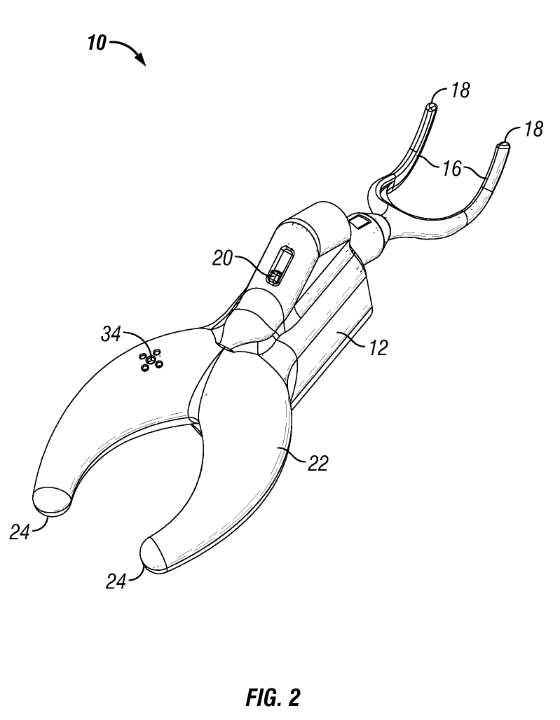

FIG. 3 is a perspective view of the device body with three different tips.

FIG. 4 is another perspective view of the device of FIG. 5 showing a laser light marking feature.

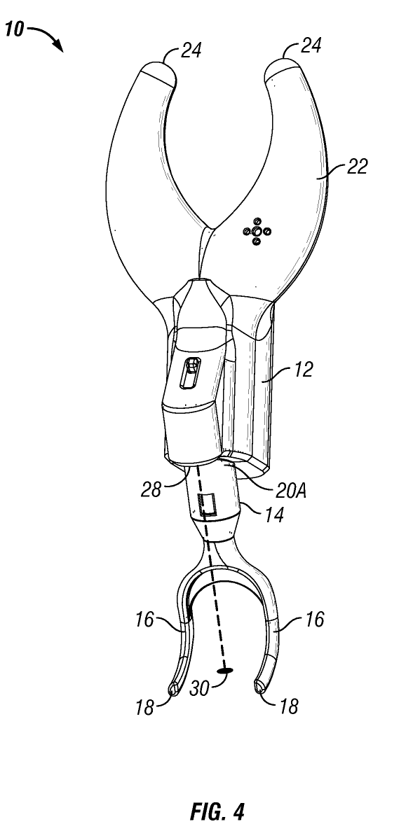

FIGS. 5 and 6 are perspective views of the tool body with a battery compartment.

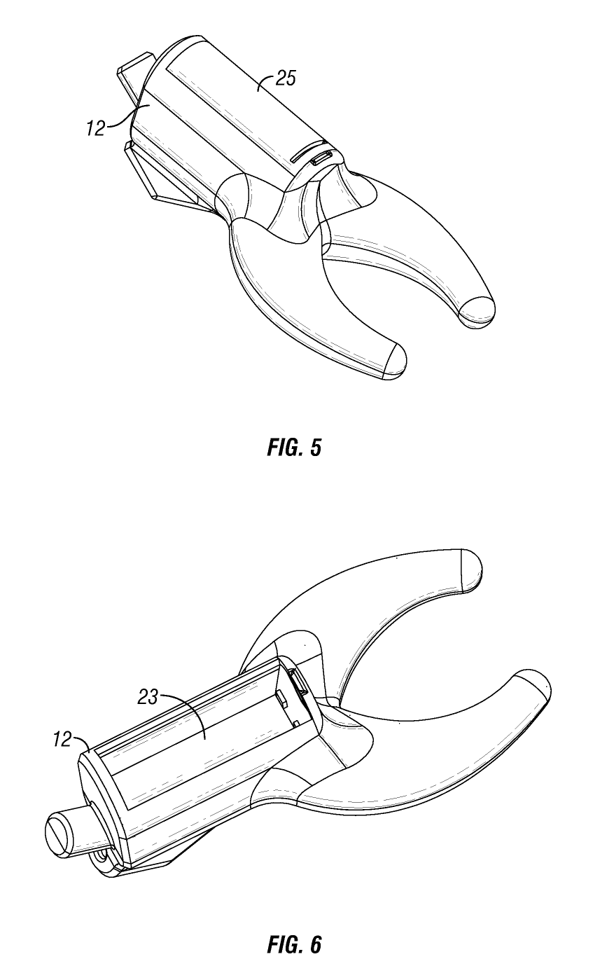

FIG. 7 is a sketch of another alternative embodiment of the vibration tool having a clip or band for mounting the tool on a user's finger.

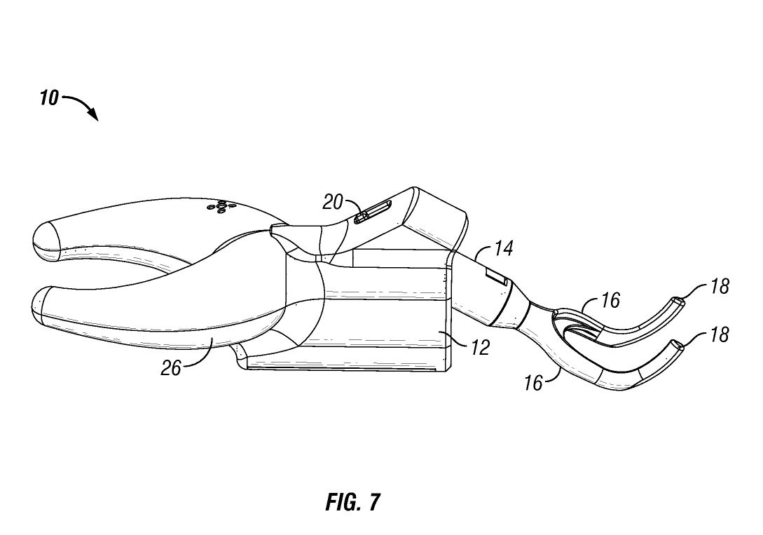

FIG. 8 is an exploded view of the components of the device.

### DETAILED DESCRIPTION OF THE PREFERRED EMBODIMENT

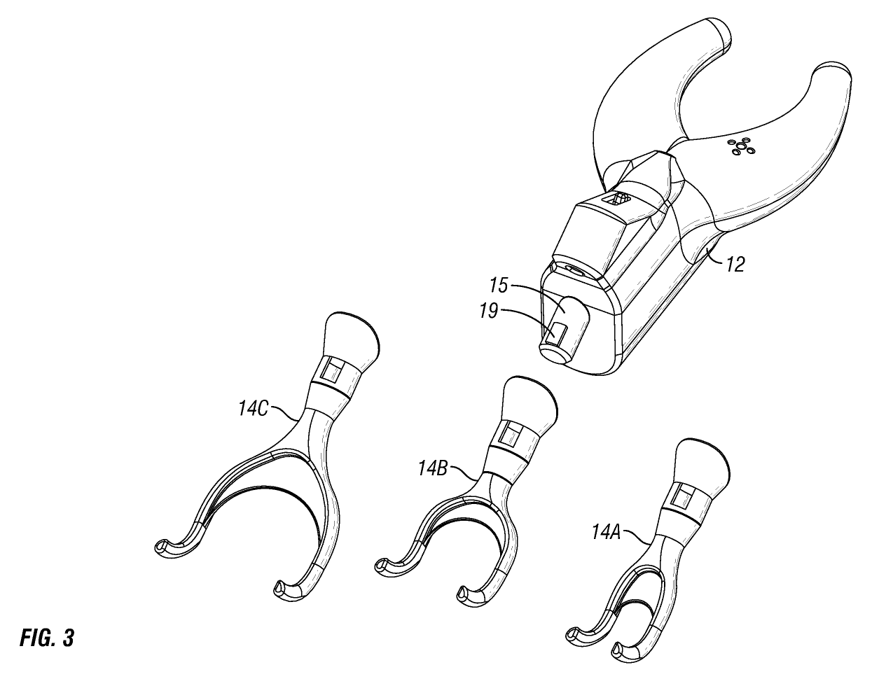

The device or tool of the present invention is used to vibrate a zone or areas on the patient's skin to create an anesthetic or analgesic numbing effect in the zone prior to a medical procedure which otherwise would cause some level of pain to the patient. The device or tool 10 includes a body 12 which houses a vibration generator, such as a small or micro electric motor 13. A forked tip 14 is removably mounted on the body 12 and includes a pair of curved prongs 16 which terminate in spaced apart ends 18. The tip 14 can be mounted on the body 12 in any convenient manner, such as a quick connect coupling, mating threads, a friction fit, a spring bias detent, a trust lock, or a lock pin. As seen in FIGS. 3, 6 and 8, the body 12 includes a male extension 15 and the tip 14 includes a female receptacle 17 to receive the extension 15. A detent 19 provides a quick release coupling between the body 12 and tip 14. It is understood that the male and female coupling may be reversed with the male plug on the tip 14 and the female receptacle on the body 12. Preferably, the ends 18 are convex to provide sufficient contact with the skin. Preferably, a set of interchangeable tips 14 are provided for selective mounting on the body 12, with the space or diameter between the ends 18 of each prong 16 varying. For example, one tip 14A may have prongs with ends spaced one centimeter apart, while other tips 14B, 14C have prongs with ends spaced two centimeters and three centimeters apart, as shown in FIG. 3. An appropriate tip 14 can be selected depending upon the size of the zone which needs to be anesthetized.

The tool 10 includes a power source which is operatively connected to the vibration generator in the body 12. For example, the power source may be one or more batteries 21 housed in a compartment 23 in the body 12 with a removable cover or lid 25. Positive and negative contacts are operatively provided in the body 12 to provide electrical connection between the battery and the electric motor 13. Alternatively, the body 12 may have a hard wire connection for plugging into an electrical outlet. A switch 20 is provided on the body 12, and is moveable between on and off positions so as to control actuation of the power source 21, and thereby start and stop the vibration generator 13. In the preferred embodiment, the switch 20 is a slide-type switch moveable between an “OFF” position and one or more “ON” positions. Alternatively, the switch may be a rotatable switch which can be easily operated with the hand holding the tool 10. It is understood that other types of switches may also be used, such as a push button switch, or a toggle switch.

Preferably, the body 12 includes a forked upper end 22 with opposite legs 24 which extend around a user's index finger. In another alternative embodiment, the body 12 includes a clip or band for mounting the tool 10 on a user's finger.

The tool 10 may also include a light 28, such as a laser marker in the body 12 which is directed to the space between the ends 18 of the tip 14 so as to provide a target 30 on the anesthesia zone 32 on the patient's skin. The target 30 defines an anesthetized spot for the injection when the tool 10 is turned on.

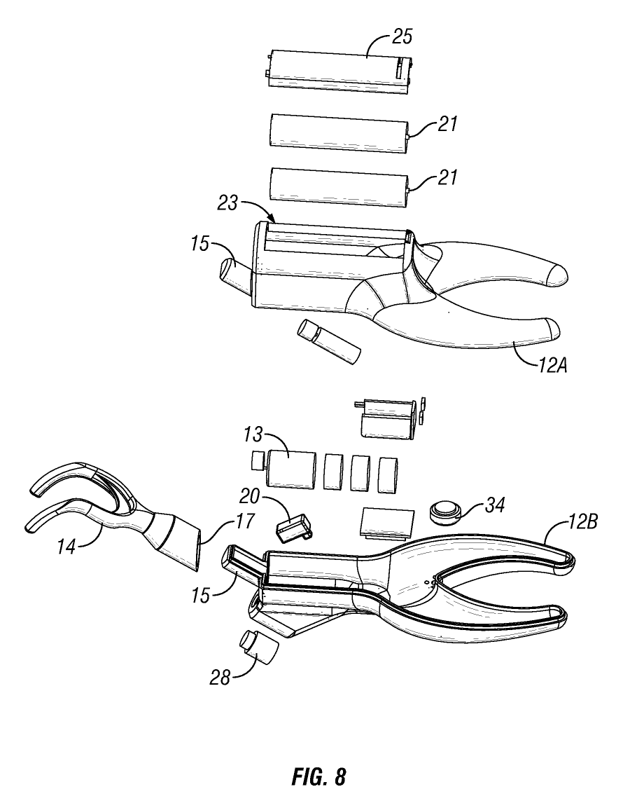

FIG. 8 shows that the body 12 is formed in two halves 12A and 12B. Preferably, the body halves 12A and 12B are plastic, to minimize the weight of the tool 10. The upper half 12A houses the batteries 21 in the compartment 23, while the lower half 12B houses the motor 13, light 28 and sound chip 34. The halves 12A and 12B may be joined in any convenient manner, such as screws, adhesive, or plastic welding. It is understood that the body 12 may take other shapes and forms than those shown in the drawings.

The tool 10 eliminates or substantially reduces pain during a medical procedure, such as a shot. Such pain reduction or elimination is particularly useful in pediatrics and with patients who need numerous shots, such as diabetics receiving insulin shots on a daily or more frequent basis. The tool can be used by a medical professional, including a doctor, a nurse, or a physician's assistant, or may be used by the patient himself or herself who gives their own shots.

The small size of the tool makes it easy to handle and store. The interchangeable tips allows smaller or larger anesthesia zones. For example, for a finger prick to draw blood, the smallest tip can be utilized. For an injection, such as insulin, the meeting tip can be used. For a larger bore needle used in drawing blood, the larger tip can be used.

The tip 14 can also be designed in various shapes so as to further detract the patient, particularly a child, from the shot. For example, the ends 18 of the tip 14 can be shaped like butterfly wings, feet, hands, or other fun or ornamental designs. A voice chip or sound speaker 34 may also be provided in the body 12 to generate a whimsical noise to further distract a child or other needle-phobic patient. In use, when the switch 20 is moved to a first or “ON” position, the vibration generator 13 and light 28 are both on. Moving the switch to a second position activates the voice chip.

The tool 10 can be held in a first position so that only the ends 18 of the tip 14 touch the patient's skin, or in a second position so that a length of the prongs 16 engage the skin. Thus, the device 10 can be turned 180° for use in either the first or second position. In either position, the spaced apart prongs 16 create overlapping vibration waves which produce an enhanced anesthetic effect. Tool 10 is easy to grasp, easy to aim, and is stable, in both the positions.

The invention has been shown and described above with the preferred embodiments, and it is understood that many modifications, substitutions, and additions may be made which are within the intended spirit and scope of the invention. From the foregoing, it can be seen that the present invention accomplishes at least all of its stated objectives.

1. A tool for vibrating anesthesia, comprising:
a body having a forked upper end to fit on opposite sides of a user's finger;
a vibration generator housed in the body;
a power source operatively connected to the vibration generator;
a switch moveable between on and off positions to control actuation of the power source to thereby start and stop the vibration generator;
a tip removably mounted on the body and having at least two prongs with spaced apart ends to transmit vibrations from the generator to an anesthesia zone on a patient's skin when the prongs ends touch the skin thereby numbing the zone; and
the prongs defining an injection target within the anesthesia zone between the prong ends for a needle rejection.

2. The tool of claim 1 further comprising interchangeable tips each having at least two prongs, with the prongs on one tip having greater spacing therebetween than the prongs on another tip.

3. The tool of claim 1 further comprising a light on the body directed towards the anesthesia zone to locate the injection target.

4. The tool of claim 1 further comprising a voice chip speaker to generate a sound when the switch is on.

5. The tool of claim 1 wherein the power source is a battery.

6. The tool of claim 1 wherein the vibration generator is an electric motor.

7. The tool of claim 1 wherein the body has a V-shape.

9. The tool of claim 1 wherein the tip is connected to the body without tools.

10. The tool of claim 1 wherein the prongs include curved portions terminating in the spaced apart ends.

11. The hand-held vibrating medical tool for localized anesthesia, comprising:
a body to be held in user's hand;
a first tip having forked prongs with spaced apart ends to engage a patient's skin so as to define an injection target between the prongs ends;
a motor in the body to vibrate the tip and prongs; and
a switch to actuate the motor.

12. The tool of claim 11 wherein the body has a formed upper end to receive the user's index finger.

13. The tool of claim 11 wherein the body has a Y-shape.

14. The tool of claim 11 wherein the tip has a Y-shape.

15. The tool of claim 11 further comprising a light on the body directed to the injection zone.

16. The tool of claim 11 further comprising a second tip with forked prongs interchangeable with the first tip, and the prongs of the first and second tips having different diameters.

17. The tool of claim 11 further comprising a sound generator to emit a noise when the motor is actuated.

18. The tool of claim 11 wherein the prongs include curved portions terminating in spaced apart ends.

19. The tool of claim 11 wherein the tip is mounted to the body with a male and female coupling.

20. The tool of claim 11 wherein the tip is connected to the body without tools.
